(19) United States
(12) Patent Application Publication
(10) Pub. No.: US 2010/0048380 A1
(43) Pub. Date: Feb. 25, 2010

(54) Novel catalyst for oxygen reduction reaction in fuel cells

(75) Inventors: Scott A. Calabrese Barton, East Lansing, MI (US); Kothandaraman Ramanujam, Ottawa (CA); Vijayadurga Nallathambi, East Lansing, MI (US)

Correspondence Address: HARNESS, DICKEY & PIERCE, P.L.C., P.O. BOX 828, BLOOMFIELD HILLS, MI, 48303, US

(73) Assignee: Board of Trustees of Michigan State University, East Lansing, MI (US)

(21) Appl. No.: 12/583,532

(22) Filed: Aug. 21, 2009

Related U.S. Application Data
(60) Provisional application No. 61/090,780, filed on Aug. 21, 2008.

(51) Int. Cl. B01J 27/20; B01J 37/34

(52) U.S. Cl. 502/5; 502/174

(57) ABSTRACT

A method for making a carbon-metal-nitrogen oxygen reducing cathode catalyst, the method comprising mixing a carbon source with a transitional metal precursor to form a metal precursor loaded carbon substrate; adding a nitrogen precursor compound to the metal precursor loaded carbon substrate to form a carbon-metal-nitrogen precursor; and pyrolyzing the carbon-metal-nitrogen precursor in a closed vessel, thereby forming an oxygen reducing cathode catalyst. The carbon-metal-nitrogen catalyst requires no precious metal such as Pt, and also provides benefits such as controlled deposition of catalytically active nitrogenous compounds that can increase the catalytic activity of the catalyst when compared to gaseous deposition of nitrogen to the surface of the carbon support.

### CROSS-REFERENCE TO RELATED APPLICATIONS

This application claims the benefit of U.S. Provisional Patent Application No. 61/090,780, filed Aug. 21, 2008. The entire disclosure of the above application is incorporated herein by reference.

### BACKGROUND

The present technology relates to methods for producing improved metal, nitrogen, and carbon containing catalysts effective for the reduction of oxygen in low temperature fuel cells and other electrochemical reactions and cathode catalysts produced by these methods.

There is an increasing interest to replace platinum (Pt) based electro-catalysts with cost-effective non-noble catalysts for the oxygen reduction reaction (“ORR”) in low-temperature fuel cells, such as Polymer Electrolyte Fuel Cells (PEFCs) and Direct Methanol Fuel Cells (“DMFCs”) etc. Non-noble metal catalysts based on iron (Fe) and cobalt (Co) ions are among the possible candidates for replacement of Pt based catalyst metals for ORR. These catalysts are active towards ORR and exhibit selectivity towards ORR in the presence of a fuel, thereby increasing the volumetric energy density of a DMFC.

Others in the field have discovered the catalytic nature of nitrogen-doped carbon materials, and subsequently various non-precious metal catalysts were produced by pyrolyzing materials such as metal-N₄ macrocyles adsorbed on carbon black in an inert atmosphere. Others have demonstrated an active catalyst for ORR by pyrolyzing a metal precursor (cobalt acetate), carbon black and a nitrogen precursor such as polyacrylonitrile in inert atmosphere. Following this approach, many methods have been developed to prepare non-noble metal catalysts, including these steps: (a) heat-treating carbon-supported organometallic complexes by pyrolyzing a metal source with carbon source in ammonia or acetonitrile atmosphere, (b) cosputtering cobalt or iron and carbon in a nitrogen atmosphere with or without subsequent heat-treatment, and (c) mixing nitrogen-containing ligands with cobalt oxide solution which are subsequently entrapped in polypyrrole matrix supported on carbon.

Recently, investigators have ball-milled highly-ordered synthetic graphite for use as a carbon support as it contains low levels of iron as impurities and low surface area (3.5 m²/g), Pyrolysis of the milled material with an iron source in ammonia environment produced catalysts with nitrogen content as high as 4 atom %. These nitrogen containing catalysts demonstrate that the catalytic activity increases as a result of decreasing metal crystallite size, increasing degree of disorder, nitrogen content, and microporous (<22 Å) specific surface area. Others in the field have also suggested that active sites containing pyridinic nitrogen can be responsible for the catalytic activity for ORR and reported low levels of H₂O₂ production while reducing oxygen in an acidic medium.

U.S. Patent Application Publication No. 2007/0248752, O'Brien et al., published Oct. 25, 2007, discloses making an oxygen-reducing catalyst layer. The catalyst layer is prepared by physical vapor depositing (PVD) a transition metal onto a carbon support under a reduced pressure (e.g. about 1×10⁻⁵ Torr or less). After a film of catalyst metal has been applied to a substrate, the resulting coated substrate is thermally treated either separately or as part of the PVD step. The thermal treatment and/or PVD treatment can be performed under a nitrogen gas environment to provide a source of nitrogen to the catalyst. The thermal treatment can comprise heating the coated substrate for 15 minutes or so at temperatures of at least 600-900° C. However, the deposition of the nitrogen source is not readily controllable. Moreover, it is believed that a greater amount of nitrogen can be incorporated into a high-surface area support by introducing nitrogen at higher activity (for example, higher partial pressure) in the presence of the carbon support in contrast to the use of gaseous nitrogen at reduced pressure.

As such there is a need for alternative methods for producing alternative catalyst materials having improved catalytic activity. There is also a need for methods to increase the availability of nitrogen target sites on catalytic supports for oxygen reduction reactions and provide enhanced stability of these alternative catalysts when used in acidic fuel cell environments.

### SUMMARY

The present technology provides methods for making non-precious metal electrochemical cathode catalysts for the reduction of molecular oxygen, for example, in a fuel cell. In addition, the present technology provides for a method to control the anchoring of a nitrogen containing compound on a high surface area carbon surface, which actively contributes to the catalytic activity of the cathode catalyst over preexisting methods of depositing nitrogen, thereby effectively increasing the catalytic activity per unit mass of catalytic material on a substrate. The cathode catalyst material produced in accordance with the present technology lowers the cost for producing the catalyst material and follows a simple synthesis method compared to platinum/carbon catalysts and other non-precious metal catalysts conventionally used in fuel cell designs.

In one aspect, the present technology provides a method for making a carbon-metal-nitrogen oxygen reducing cathode catalyst, the method comprising:
(a) mixing a carbon source with a transition metal precursor to form a metal precursor loaded carbon substrate;
(b) adding a nitrogen precursor compound to the metal precursor loaded carbon substrate to form a carbon supported metal-nitrogen complex precursor; and
(c) pyrolyzing the carbon-metal-nitrogen precursor in a closed vessel to form an oxygen reducing cathode catalyst.

In another aspect, the present technology provides for a method for preparing a carbon-metal-nitrogen oxygen reducing cathode catalyst for a fuel cell, the method comprising:
(a) mixing a carbon source with a transitional metal precursor to form a carbon-metal substrate;
(b) pyrolyzing the carbon-metal substrate in a reducing or neutral environment in a vessel charged at a pressure ranging from about 2 bar to about 100 bar to form a carbon-metal nanostructure; and
(c) contacting the surface of the pyrolized carbon-metal nanostructure with a nitrogen precursor compound to form a oxygen reducing cathode catalyst.

Further, the present technology provides for a method for making a membrane electrode assembly for a fuel cell, the membrane electrode assembly comprising:
(a) an ionomeric membrane;
(b) an anode catalyst disposed on a first surface of the ionomeric membrane; and
(c) a cathode catalyst disposed on a second surface of the ionomeric membrane wherein the cathode catalyst is synthesized by:
   (i) mixing a carbon source with a transition metal precursor to form a metal precursor loaded carbon substrate;
   (ii) adding a nitrogen precursor compound to the metal precursor loaded carbon substrate to form a carbon supported metal-nitrogen complex precursor; and
   (iii) pyrolyzing the carbon supported metal-nitrogen complex precursor in a closed vessel to form an oxygen reducing cathode catalyst.

### DRAWINGS

The drawings described herein are for illustration purposes only and are not intended to limit the scope of the present technology in any way. The patent or application file contains at least one drawing executed in color. Copies of this patent or patent application publication with color drawings will be provided by the U.S. Patent and Trademark Office upon request and payment of the necessary fee.

FIG. 1 is a flow diagram of a method for making an oxygen reduction cathode catalyst in accordance with the methods of the present technology.

FIG. 2 is a flow diagram of a method for making an alternative oxygen reduction cathode catalyst in accordance with the methods of the present technology.

FIG. 3 shows the polarization curves obtained for various catalysts synthesized at 40° C. in 1N aqueous sulfuric acid, showing effect of heat-treatment temperature on the catalytic activity towards ORR.

FIG. 4 shows the plot of current density as a function of nominal nitrogen content observed at three different potentials.

FIG. 5 shows a Koutecky-Levich analysis performed on catalysts loaded with 10.3% nitrogen.

FIG. 6A shows a polarization curve obtained from rotating ring disc electrode (“RRDE”) measurements at 40° C. in 1N aqueous sulfuric acid; FIG. 6B shows a disk potential dependent H₂O₂ production curve for the optimized catalyst of the present technology having a nominal nitrogen of 10.3% coated on a rotating ring disc electrode (“RRDE”).

FIG. 7A shows the surface area distribution of various catalysts with different nominal nitrogen % content obtained from BJH desorption employing Halsey-Faas correction; FIG. 7B depicts a calculated BET area for various catalysts with different nominal nitrogen content (%).

It should be noted that the figures set forth herein are intended to exemplify the general characteristics of an apparatus, materials and methods among those of this invention, for the purpose of the description of such embodiments herein. These figures may not precisely reflect the characteristics of any given embodiment, and are not necessarily intended to define or limit specific embodiments within the scope of this invention.

### DETAILED DESCRIPTION

The following description is merely exemplary in nature and is not intended to limit the present technology, application, or uses.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations of the stated features. Specific Examples are provided for illustrative purposes of how to make, use and practice the catalytic compositions and methods of this invention and, unless explicitly stated otherwise, are not intended to be a representation that given embodiments of this invention have, or have not, been made or tested.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As used herein, the word “include,” and its variants, is intended to be non-limiting, such that recitation of items in a list is not to the exclusion of other like items that may also be useful in the materials, compositions, devices, and methods of this technology.

In accordance with the various embodiments of the present technology, it has been discovered that an effective way of preparing a cathode-catalyst which, is used in low temperature fuel cells and other electrochemical cell applications can be achieved by pyrolyzing the catalyst components under high temperature in a closed vessel. The vessel can be pressurized due to the catalyst-components (autogenic pressure) to deliver a finite and specific amount of nitrogen content to the catalyst and more particularly, to control the ratio of nitrogen to carbon. In various embodiments, methods produce cathode catalysts with higher yields without gasifying carbon precursor. Having processes capable of producing a more efficient and non-gasified catalysts directly translates to a higher catalytic activity per unit of mass, volume and a lower cost per unit catalytic activity.

Although the present technology is not limited to or dependent on a particular theory, it is believed that the transition metal/nitrogen component on the carbon support promotes the reduction of molecular oxygen to water.

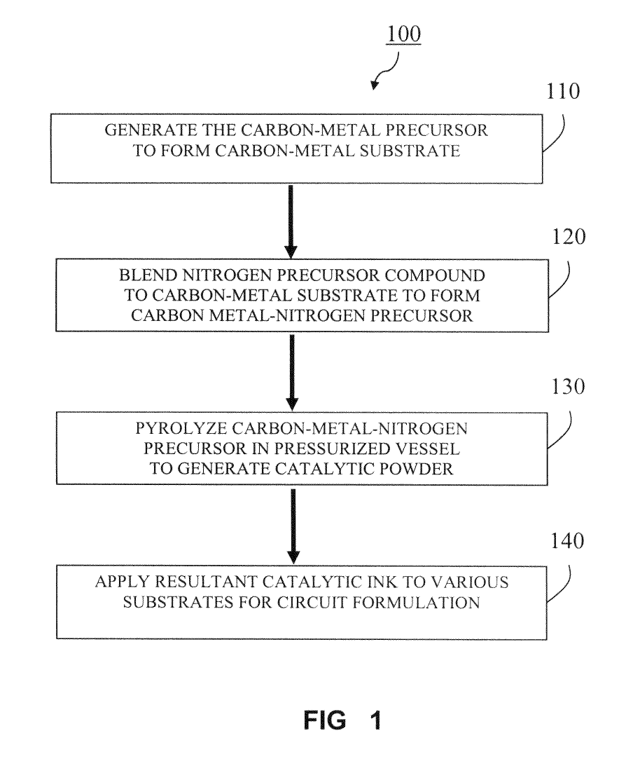

FIG. 1 represents a flow diagram of method 100 for making a cathode catalyst for the reduction of oxygen typically found in a fuel cell and includes steps 110-140. Method 100 initially involves generating a carbon-metal substrate (step 110). Step 110 generally involves mixing a carbon support and a transition metal precursor. In some embodiments, the carbon support and transition metal precursor are mixed in the presence of a chemically compatible solvent, for example, a small chain alcohol and water. The alcohol can be any C₁-C₆ alcohol, for example, ethanol, isopropyl alcohol, n-propyl alcohol and butanol which are readily or moderately miscible with water, the carbon support and the transition metal. The dispersion can be stirred for one to six hours to have the transition metal precursor deposited to the carbon support.

In some embodiments, the amount of transition metal added to the carbon support (as a percentage of dry weight of the two components) can range from about 0.1% by weight to about 10% by weight, or from about 0.5% to about 10% by weight, or from about 0.75% to about 10% by weight, or from about 1% to about 10% by weight, or from about 2% to about 10% by weight, or from about 5% to about 10% by weight, or from about 0.1% to about 8% by weight, or from about 0.1% to about 6% by weight, or from about 0.1% to about 5% by weight, or from about 0.1% to about 3% by weight, or from about 0.1% to about 2% by weight.

### Carbon Support

The carbon support can include any activated or non-activated carbon material, generally having a high surface area. In some embodiments, the carbon support can include one or more of the following illustrative examples of carbon supports including: carbon powder, carbon black, acetylene black, activated carbon, carbon fiber, fullerene, nano-carbon or combinations thereof. Specific examples of carbon supports among those useful in the present technology include Norit® SX Ultra (Marshall, Tex., USA), Ketjenblack® (600J and 300J, Akzo-Nobel Polymer Chemicals, Chicago, Ill., USA), C55 carbon particles (Chevron Phillips Chemical Company, TX), Black Pearls® (Cabot Corporation, Boston, Mass., USA), Printex® XE (Degussa Engineered Carbons, Parsipanny, N.J., USA), pyrrole black, activated charcoal, graphitic powder, Vulcan® XC72 (Cabot Corporation, Boston, Mass., USA) and pyrolyzed form of perylene tetracarboxylic anhydride (PTCDA), polyacrylonitrile (PAN), and combinations thereof.

Ketjenblack® is an electroconductive carbon black, in pellet form, having a pore volume of from about 300 ml/100 g to 520 ml/100 g (e.g., 310-345 ml/100 g, and 480-510 ml/100 g) with fines (<125 micron) of less than about 7%, a pH of 8-10, and an apparent bulk density of from about 100 to about 150 kg/m³ (e.g., 125-145 kg/m³, and 100-120 kg/m³). Black Pearls® engineered pigment black has an OAN of 65 cc/100 g, a 325 mesh residue of less than 200 ppm, and a density of 430 kg/m³. C55 carbon black consists of acetylene black carbon particles, 99.99% purity, having a surface area of 82 m²/g, and is commercially available under the trade designation “Shawinigan Black, Grade C55.” Norit® SX Ultra is an acid washed, steam activated carbon having a surface area (BET), of about 1200 m²/g, an apparent density, tamped, of 0.32 g/mL, a particle size distribution of d10 of 5 μm, d50 of 25 μm, d90 of 100 μm, and a pH of about 7. Printex® carbon black has a CTAB surface area of 600 m²/g, an OAN of 380 ml/100 g, a COAN of 370 ml/100 g, a sieve residue, 325 mesh of 20 ppm, and a pour density of 130 g/dm³. Vulcan® is a conductive carbon black pellet or powder having an OAN of about 174 cc/10 g, surface area of 210 m²/g, 325 mesh residue of less than 25 ppm, and density of about 264 kg/m³.

Oxidized carbon supports (oxidized for example by HNO₃/H₂SO₄) and other carbides, nitrides and silicides of metals, for example, titanium carbide (TiC), tungsten carbide (WC), titanium nickel carbide (TiN) and silicon carbide (SiC) can all be used as a carbon support in the present methods. The nano-carbon supports can include carbon nanotubes, carbon nanofibers, carbon nanowires, carbon nanohorns and carbon nanorings.

### Metal Precursor Molecules

The transition metal plays an important role in the catalytic activity of the present catalysts. The transition metal is preferably substantially free of all precious metals, such as ruthenium, rhodium, palladium, osmium, iridium, platinum, gold, and silver. Precious materials have high material costs, and are required in large amounts to achieve desirable operation voltages and currents. In comparison, examples of suitable transition metals for the transition metal target include iron, cobalt, nickel, chromium, cerium, zinc, zirconium, molybdenum and manganese. These suitable transition materials are less expensive than precious metals, thereby reducing material costs during manufacturing. In addition to the transition metals in ionic form, the present methods also contemplate the use of these transition metals in the form of transitional metal macrocycles, transition metal salts and combinations thereof.

The transition metal macrocycle comprises a large, generally ring or crown-like molecule such as a phthalocyanine, having a metal atom retained in its central portion, generally by co-ordinatively bonding with one or more of nitrogen, oxygen and/or other atoms having an unshared pair of electrons, or delocalized electrons, as for example in a bond. Other examples of macrocycles include metallocenes, porphyrins, chlorophyll derivatives of imidazoles or pyrroles and the like. While a variety of transition metals may be employed in the practice of the present technology, some particularly preferred transition metals include iron, cobalt, nickel, chromium, cerium, zinc, zirconium, molybdenum and manganese.

Dispersion of the transition metal containing macrocycles may be accomplished by dissolving the macrocyclic compound in a solvent, dispersing the carbon support material into the solvent, and evaporating the solvent to provide a support material having the transition metal macrocyclic compound adsorbed onto the carbon support. In other embodiments, the adsorption may be accomplished by ball milling the materials together or by evaporating the macrocyclic compound onto the support substrate provided that the macrocyclic compound has sufficient volatility.

In some embodiments, the transition metal macrocycles can include one or more of transitional metal organometallic derivative complexes. Such organometallic macrocycles can include for example cobalt pthalocyanine, iron pthalocyanine, iron and cobalt naphthalocyanine, cobalt tetraazannulene, iron tetramethoxy phenyl porpyrin chloride, tetracarboxylic cobalt, iron pthalocyanine, tetramethoxy phenyl porpyrin chloride, cobalt salen-N,N′-bissalicylidine, ethylenediaminocobalt, cobalt-anten-O-amino, ferrocene, benzaldehyde, dimethylglyoxime, ethylenediamino cobalt and iron phenanthroline.

In some embodiments, the transition metal precursor may be a transition metal salt. In various embodiments, the transition metal salt is a combination of a transition metal cation, for example: Fe²⁺, Fe³⁺, Co²⁺, Co³⁺, Cr²⁺, Cr³⁺, Cr⁶⁺, Mn²⁺, Mn³⁺, Mn⁴⁺, Mn⁷⁺, Zn²⁺, Ni²⁺ and Ni³⁺ paired with a common anion species, for example, acetate, formate, nitrate, chloride, sulfate, oxy-chloride and phosphate. In some embodiments, preferred transition metal salts can include, for example, ferrous and ferric salts with one or more of acetate, formate, chloride, sulfate, oxy-chloride, phosphate anions; cobaltous and cobaltic salts with one or more of chloride, acetate, nitrate, sulfate anions; chromium acetate; cerium acetate; zinc chloride and zirconium acetate.

As shown in FIG. 1, step 120 provides for the addition or blending of a nitrogen precursor compound with the metal precursor loaded carbon substrate to form a carbon-metal-nitrogen precursor. The amount of the nitrogen precursor added to the carbon-metal substrate prior to pyrolysis can vary depending on the specific application requiring the cathode catalysts of the present technology. In some embodiments, the metal precursor loaded carbon-metal substrate in the form of powder or granular particles can be admixed with the nitrogen precursor in any suitable mixing vessel. In some embodiments, the carbon-metal substrate and the nitrogen precursor can be mixed together in a mortar with a pestle.

Typically, for fuel cell cathode catalysis (both hydrogen and methanol fuel cells), a mixture of metal precursor loaded carbon substrate and a nitrogen precursor in a range of 1-20 nominal weight % can be used to prepare the cathode catalysts of the present technology. In some embodiments, the carbon-metal-nitrogen precursor can contain an amount of nitrogen precursor (weight % nominal nitrogen) ranging from 1% to about 18%, or from about 1% to about 15%, or from about 1% to about 12%, or from about 1% to about 9%, or from about 1.5% to about 15%, or from about 6% to about 15%, or from about 9% to about 15%, or from about 10% to about 15%, or from about 12% to about 15%. In some embodiments the carbon-metal-nitrogen precursor can contain an amount of nitrogen precursor (weight % nominal nitrogen content) ranging from 1% to about 15%, more preferably from 1.5 to about 12% by weight.

### Nitrogen Precursor Molecules

In various embodiments of the present technology, a nitrogen containing precursor compound is added to the metal precursor loaded carbon substrate as shown in method step 120. Without wishing to be bound to any specific theory, it is believed that the after pyrolysis metal-NₓC_{y} type of catalytic sites are formed possessing high catalytic activity for oxygen reduction as well as enhanced resistance to methanol poisoning while reducing oxygen. (Gupta, S. et al., J. Appl. Electrochem. (1998), 28:673-682).

In some embodiments, the nitrogen precursor is one or more heterocyclic nitrogen containing organic aromatic compounds and polymers comprising heterocyclic nitrogen containing organic aromatic compounds, including, for example, porphryins, pyridines, pyrimidines, quinolines, aromatic amines and polymers of pyrrole and aniline.

In some embodiments, the nitrogen precursor can include one or more nitrogen containing precursor molecules, for example, porphryins, pyridines, pyrimidines, aromatic amines, amines, urea and urea derivatives, poly(quinoxaline), nitroaniline, 1,10 phenanthroline, pthalocyanine, pyridine, bipyridine, polyaniline, pyrrole, polyvinyl pyridine, Pyridine based ligands-1,6 bis(4′-pyridine)-2,5-diazahexane (BPDH), Bipyridine based ligands e.g. 4,4′ bipyridine, terpyridine ligands: 4′phenyl 2,2′-6′,2′-terpyridine, 2-2″ bipyrimidine, 4-7 phenanthroline dipyrido[3,2,2′3′ phenazine], 3-nitrophalimide, p-phenylazophenol, 6-quionoline carboxylic acid, 6-nitrobenzimidazole, 5-amino 6-nitro quinoline, 2,3 naphthalocyanine, 4,4′-azoxydibenzoic acid, 2 amino 5-nitro pyrimidine, hematin, 4,4′ azo-bis[cyanovaleric acid], heamotoporpyrin dihydrochloride, 4,4′ nitrophenyl azo catechol 4,6 dihydroxy pyrimidine, nitrophenyl, benzylamine, 1,6 phenylendiamine, tetracyanoquinodimethane, propylene di-amine, ethylene diamine, urea, selenourea, thiourea, dimethylformamide, ammonia and acetonitrile.

Once the carbon-metal-nitrogen precursor has been prepared, the next step in the synthesis of the present cathode catalysts is to pyrolyze the carbon-metal-nitrogen precursor in a closed vessel, in which reactions occurs at its autogenic pressure

As shown in FIG. 1, method step 130, the carbon-metal-nitrogen precursor is placed in a pressure resistant vessel capable of sustaining the interior of the vessel with a reducing or neutral (inert) gaseous environment. Placing carbon-metal-nitrogen precursor in a vessel capable of withstanding both elevated temperatures and internal pressures, sealing of the vessel (with the precursor compounds inside) and heating of that vessel to elevated temperature, where the elevated internal pressure results from the existence of a gaseous phase for some or all of the resulting chemical constituents. While the inner vessel wall can in principle react to some extent (catalytically or non-catalytically) with the confined chemical species, and permit some degree of diffusion of atoms or molecules into the vessel from the interior of the vessel, the vessel must limit such processes to the extent of maintaining a substantial portion of the initial atoms in the vessel (as opposed to permitting substantial diffusion of atoms and/or molecules into and/or through the containment vessel or forming compounds with the inner vessel wall material and thus not being further available for reaction). The vessel materials, apart from the above general requirements, can in principle vary widely. A thick-walled quartz vessel was found to possess the necessary mechanical strength at high temperature and pressure, minimize chemical reactions with the reactants and minimize diffusion of the reactants into the vessel wall. However, other containment materials could be used for this purpose. In some embodiments, the vessel may be made from any industrial metal, for example heat and pressure resistant stainless steel. In some embodiments, the vessel can be made from quartz commonly used to digest or pyrolyze organic matter. Alternatively, any industrial vessel capable of passing a reducing or neutral gas into a chamber and capable of operating at an internal pressure of at least 2 bar can be used.

In method step 130, the carbon support is pyrolyzed (i.e., heated) at a temperature preferably in the range of from about 500° C. to about 1200° C., and more preferably from about 600° C. to about 1,000° C. The pyrolysis step may be accomplished, for example, using a rotary kiln, a fluidized bed reactor, or a conventional furnace. The contents of the vessel can be then thermally treated by placing the vessel in a furnace or other heating apparatus capable of thermally treating the contents of the pressurized vessel to at least 1000° C. This is accomplished by thermally treating the precursor material under elevated pressure, for example, pyrolizing the carbon-metal-nitrogen precursor in a vessel with an internal pressure of about 2 bar to about 100 bar.

A typical pyrolysis process 130 can employ a thermal treatment schedule, for example, the carbon-metal-nitrogen precursor material can be heated from a starting temperature of 5° C. over a period of 15 minutes to a temperature of 150° C. and held at that temperature for 20 minutes. Thereafter, the temperature can be raised over a period of 30 minutes to a pyrolysis temperature in the range of 600-900° C., and held at that temperature for approximately 30-360 minutes.

Thereafter, the pyrolyzed material is rapidly cooled to room temperature. The cooling can be facilitated by opening the furnace or microwave device while maintaining the flow of reducing gas over the material. The contemplated pyrolysis vessel enables the pyrolysis of the carbon-metal-nitrogen precursor to yield a carbon nano-structure, for example, porous carbon nanotubes containing disordered surfaces and coated with nitrogen precursor and the transition metal.

Other embodiments may require or preferentially use a more automated form of substrate pyrolysis under elevated pressure. For example, a continuous flow spray pyrolizer (SP) injects a spray of carbon-metal-nitrogen precursor into a connected furnace under elevated pressure. The droplets are atomized from the starting precursor solution with an atomizer and the droplets are then placed in a furnace. A variety of activities may occur inside the furnace during formation of the final product including evaporation of the solvent, diffusion of solutes, drying, precipitation, reaction between the precursor and surrounding gas, pyrolysis and sintering.

Once the carbon-metal-nitrogen precursor has been pyrolized in accordance with step 130, a carbon-metal-nitrogen catalyst, which can effectively reduce oxygen, is obtained. Although, the present catalyst will find primary use in low temperature fuel cells, as the cathode catalyst in membrane electrode assemblies for oxygen reduction reactions, the present cathode catalyst also finds utility in batteries and in electrochemical sensors.

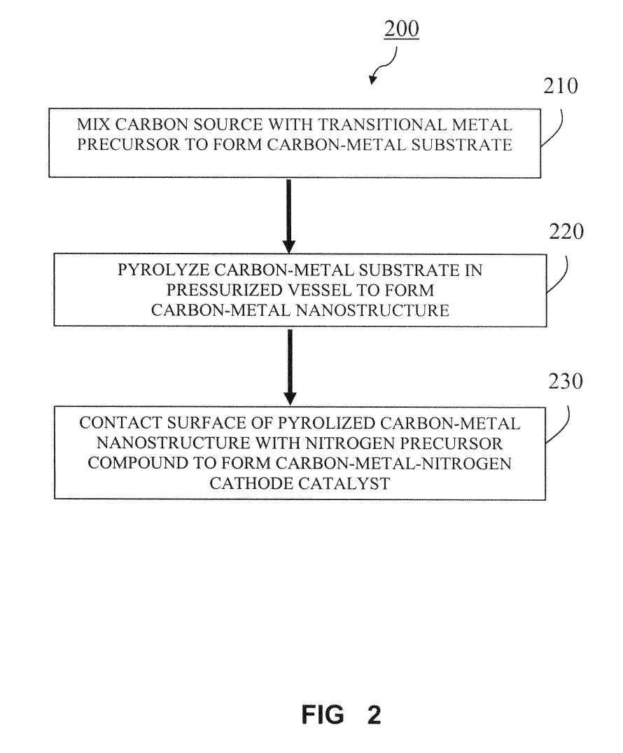

In a further embodiment, FIG. 2 shows an alternate method for making a carbon-metal-nitrogen oxygen reducing cathode catalyst. The method 200 comprises step 210 wherein a carbon support is mixed with a transitional metal precursor to form a metal precursor loaded carbon substrate as discussed above under step 110. In one embodiment, the carbon support can include one or more of carbon particles (Ketjenblack® 600JD, 600 m²/g, Akzo-Nobel Polymer Chemicals, Chicago, Ill., USA); C55 carbon particles (99.99% purity carbon, 82 m²/g, Chevron Phillips Chemical Company, TX) and Vulcan® XC72 carbon particles (210 m²/g, Cabot Corporation, Boston, Mass.). The carbon support can then be mixed with a transition metal as described above in step 110 to form a metal precursor loaded carbon substrate. The metal precursor loaded carbon substrate can then be pyrolyzed, for example, using a rotary kiln, a microwave field, a fluidized bed reactor, or a conventional furnace as shown in step 220. The pyrolysis step further includes thermally treating the metal precursor loaded carbon substrate at temperatures ranging from 600-1200° C., preferably at 600-900° C. for 30-360 minutes. In some embodiments, the metal precursor loaded carbon substrate is treated with the reducing or inert gas prior to pyrolysis, during pyrolysis and after pyrolysis to ensure that no oxide formation occurs on the surface of the catalyst

The pyrolysis step 220 of the carbon-metal-nitrogen precursors can also include pyrolyzing the carbon-metal-nitrogen precursors in a vessel at a pressure ranging from about 2 bar to about 100 bar to form a carbon-metal-nitrogen nanostructure. In step 230, the catalyst thus formed is treated with 1N sulfuric acid in order to remove the excess metal present after pyrolysis

### Devices Employing the Cathode Catalyst

Several electrochemical catalytic applications can be envisioned for the present cathode carbon-metal-nitrogen catalysts of the present technology. Returning back to FIG. 1, step 140, the catalyst powder or carbon-metal-nitrogen cathode catalyst is taken from the reaction vessel and can be admixed with an ionomeric substrate, for example, Nafion® (E. I. du Pont de Nemours, Wilmington, Del., USA) to form a catalytic ink. The catalytic ink can be applied to any variety of solid supports, including, for example, any well known cathode material used in fuel cell manufacture. In some embodiments, the catalytic ink comprising the catalyst powder or carbon-metal-nitrogen cathode catalyst is deposited on an electrolyte membrane to form a membrane electrode assembly for use in a hydrogen or methanol fuel cell.

As described above, the catalysts produced using the methods described herein have particular efficacy in polymer electrolyte fuel cells requiring oxygen reduction reactions to generate electric current. As such, the present methods can be employed to produce cathode catalysts that can be used in direct methanol fuel cells, conventional hydrogen fuel cells and other electrochemical applications requiring a oxygen reducing cathode catalyst. In some embodiments, these carbon-metal-nitrogen cathode catalysts find particular utility in membrane electrode assemblies that can be used in the aforementioned methanol and hydrogen fuel cells. Essentially, a membrane electrode fuel cell comprises an electrolyte membrane disposed between a pair catalyst layers, i.e. an anode and cathode catalyst layer. The respective sides of the electrolyte membrane are referred to as the anode surface and the cathode surface. In a typical proton exchange membrane fuel cell, (“PEM fuel cell”) hydrogen fuel is introduced into the anode portion where the hydrogen reacts and separates into protons and electrons. The electrolyte membrane transports the protons to the cathode portion, while allowing a current of electrons to flow through an external circuit to the cathode portion to provide power. Oxygen is introduced into the cathode portion and reacts with the protons and electrons to form water and heat. The reduction of the oxygen at the cathode is catalyzed by the catalysts produced by the methods described herein.

In one embodiment, ionomeric membrane is any commercially available electrolyte membrane, for example, Nafion® (poly(perfluorosulphonic acid), also commercially available as Aciplex® or Flemion®). Other ionomeric membrane materials known in the art, such as sulfonated styrene-ethylene-butylene-styrene; polystyrene-graft-poly(styrene sulfonic acid); poly(vinylidene fluoride)-graft-poly(styrene sulfonic acid); poly(arylene ether), such as poly(arylene ether ether ketone) and poly(arylene ether sulfone); polybenzimidazole; polyphosphazene, such as poly[(3-methylphenooxy) (phenoxy) phosphazene] and poly[bis(3-methylphenoxy) phosphazene]; and combinations thereof, may also be used. An anode catalyst comprises at least one metal. The at least one metal can include platinum, ruthenium, palladium, and combinations thereof, that are known and used in the art as fuel cell anode materials. The anode catalyst is typically deposited on ionomeric membrane by preparing a catalyst ink containing the at least one metal and applying the ink to one side of the ionomeric membrane. The anode catalyst can comprise a mixture of platinum and ruthenium, such as, for example, platinum-ruthenium black. The cathode catalyst of the present technology can similarly be applied to the other side of the ionomeric membrane. In some embodiments the cathode catalyst to be applied to the other side can include the oxygen reducing cathode catalyst of the present technology mixed with one or more recast ionomers. The recast ionomer can be an ionic conductor including, for example, poly(perfluorosulphonic acid), such as Nafion®, Aciplex®, or Flemion®; sulfonated styrene-ethylene-butylene-styrene; polystyrene-graft-poly(styrene sulfonic acid); poly(vinylidene fluoride)-graft-poly(styrene sulfonic acid); poly(arylene ether), such as poly(arylene ether ether ketone) and poly(arylene ether sulfone); polybenzimidazole; polyphosphazene, such as poly[(3-methylphenooxy)(phenoxy)phosphazene] and poly[bis(3-methylphenoxy)phosphazene]; and combinations thereof. In a preferred embodiment, the recast ionomer is Nafion®.

The following examples illustrate the various features and advantages of the invention and are not intended to limit the invention thereto. While the examples refer to Ketjenblack® 600JD, iron (II) acetate and 2,2′ bipyridine, it is understood that these materials represent one embodiment and that other embodiments describing different carbon supports, transition metals and nitrogen precursors described herein can be used.

### EXAMPLES

### Example 1

### Production of Carbon-Fe-Pyridine Oxygen Reduction Cathode Catalyst

Nafion® solution (1100 EW, 5 wt. %) were purchased from Alfa Aesar, (Ward Hill, Mass., USA). A 5 mm glassy carbon rotating disk electrode (“RDE”) was purchased from Pine Instruments (Grove City, Pa., USA). Ketjenblack® 600JD (Akzo-Nobel Polymer Chemicals, Chicago, Ill., USA) (CAS No. 1333-86-4) is used as carbon support, which is dispersed in 95% ethanol. To this solution, Iron (II) acetate corresponding to 1 wt. % of iron on carbon is added and the slurry is kept stirring for about 6 hr. After the solvent is evaporated and a dry composite powder is obtained, 55 mg of the composite material thus obtained is ground with varying amounts of 2,2′ bipyridine ranging from 35 to 85 mg and the powder is subsequently charged into a stainless steel bomb that has a volume of 1.7 ml. (The pyrolysis vessel (bomb) can be a closed vessel made from steel, ceramics or quartz.) The material was charged into the bomb in an inert atmosphere. At around 273° C., bipyridine decomposes and increases the pressure inside the bomb and this in turn fixes nitrogen in the catalyst. Final chemical analyses of the resulting carbon-metal-nitrogen cathode catalysts having different quantities of pyridine nitrogen were determined using CHN analysis and provided in Table 1.

TABLE 1
Chemical data on the finalized carbon-metal-nitrogen cathode catalyst.

| | | | Carbon, Hydrogen | | |
|---|---|---|---|---|---|
| | | | and Nitrogen | | |
| | Final Weight | | content data derived | | |
| Nominal | (mg) | | from CHN analysis | | |
| Nitrogen content(%) | Sample 1 | Sample 2 | C | H | N |
| 1.5 | 58 | 57 | 95.68 | 0.18 | 0.71 |
| 6.9 | 70 | 68 | 93.88 | 0.21 | 1.75 |
| 8.9 | 64 | 69 | 93.56 | 0.19 | 1.86 |
| 9.7 | 65 | 65 | 94.23 | 0.10 | 1.49 |
| 10.3 | 65 | 68 | 94.15 | 0.09 | 1.66 |
| 10.9 | | 68 | 93.75 | 0.20 | 1.53 |
| 11.3 | | 123 | 93.4 | 0.30 | 2.93 |
| 12.5 | | 138 | | | |

### Example 2

### Electrochemical Evaluation of the Cathode Catalyst Performance

The catalysts thus obtained were tested in a rotating disc electrode set up, using 1N H₂SO₄ as the electrolyte at 40° C. As will be appreciated by those of ordinary skill in the art, the rotating disk electrode (RDE) consists of a disk on the end of an insulated shaft that is rotated at a controlled angular velocity. Providing the flow is laminar over the entire disk, the mathematical description of the flow is surprisingly simple, with the solution velocity towards the disk being a function of the distance from the surface, but independent of the radial position. The rotating disk electrode is used for studying electrochemical kinetics under conditions, such as those of testing the present technology, when the electrochemical electron transfer process is a limiting step rather than the diffusion process. Hg/Hg₂SO₄ was used as the reference electrode for all the studies and a platinum wire serves as the counter electrode. A glassy carbon rotating disk electrode (4 mm diameter and 0.2 cm² area) was used as the substrate for the supported catalysts. The catalyst ink was prepared by dispersing 4 mg of the carbon-metal-nitrogen oxygen reducing cathode catalyst powder ultrasonically in a solution mixture containing 150 μl isopropyl alcohol and 50 μl Nafion® (5 wt. % solution, E. I. du Pont de Nemours, Wilmington, Del., USA). 5 μl of the cathode catalyst suspension was deposited onto the glassy carbon RDE, which was subsequently air-dried. The electrode thus obtained was immersed in a solution of 1N H₂SO₄ saturated with O₂. The flow rate of oxygen was maintained at 100 ml/min using a Rotameter.

Steady state voltammograms were recorded on the RDE using a scan rate of 0.5 mV/s and the potential was scanned between 0.85V to 0.2V vs. SHE (Standard Hydrogen Electrode) at a rotation rate of 1500 rpm. The foregoing describes the results of testing and experiments utilizing an embodiment of the catalyst of the present technology while employing the well-known rotating disk electrode system. In order to gain insight into the nature of the catalytic active sites, the surface area of the catalysts was measured using adsorption and desorption techniques using the BET theory. The BET theory is a well-known rule for the physical adsorption of gas molecules on a solid surface, and is widely used for the calculation of surface areas of solids. (Brunauer, S., Emmett, P. H. and Teller, E., J. Am. Chem. Soc., (1938), 60:309). The surface nitrogen content of the pyrolyzed samples were evaluated using X-ray photoelectron spectroscopy (“XPS”) technique and CHN and elemental analyses on the samples quantified the bulk amounts of C, H, N and Fe present in the catalysts. The morphology of the catalysts and nano-structural formation in these were observed using transmission electron microscopy (“TEM”).

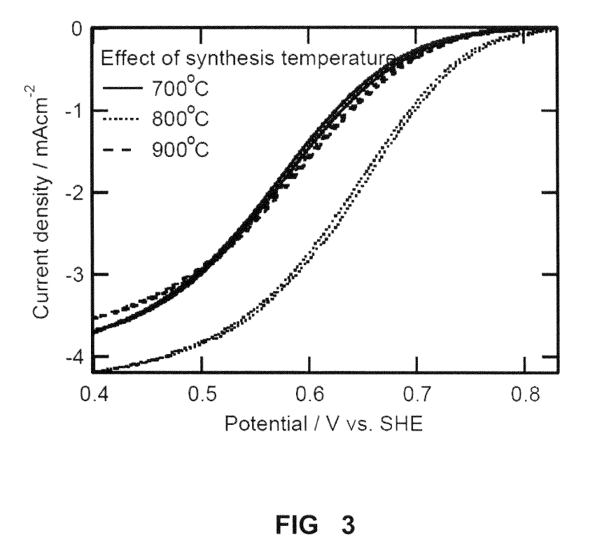

As a first step towards characterizing the catalyst, the composite (carbon+Fe(II)-acetate+bipyridine) containing 9.7 wt. % nominal nitrogen content was subjected to pyrolysis at temperatures between 700-900° C. Polarization curves shown in FIG. 3 were obtained at 40° C., while keeping RDE rotation at 900 rpm. The catalyst obtained at 700° C. and 800° C. shows similar onset potential, but improved kinetics appears for catalysts pyrolyzed at 800° C., at 2 mA/cm² current density about 20 mV more anodic potential was observed for 800° C. pyrolyzed catalysts in relation to 700° C. pyrolyzed catalyst. Loss of activity at 900° C. could be due to due to poor fixation of nitrogen in the carbon support, which could be confirmed from the CHN analysis. At 700° C., the decrease in surface area of the catalyst in relation to its 800° C. counterpart could be the reason for decreased activity.

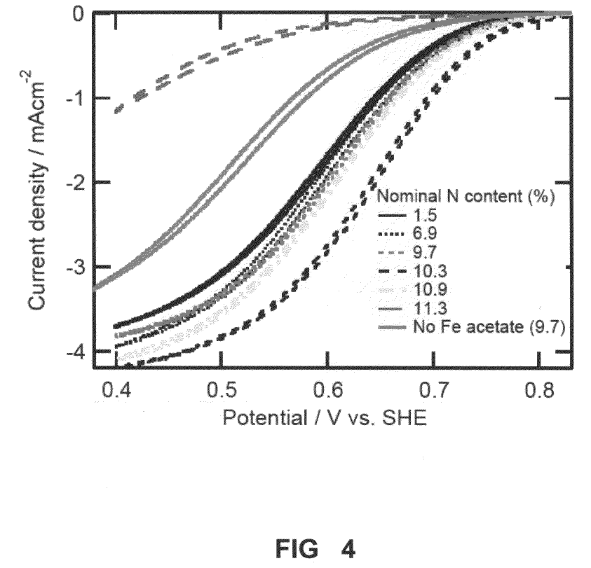

As shown in FIG. 4, the polarization curves recorded at 1200 rpm and 40° C. for a series of catalysts that were synthesized varying the amounts of nitrogen from 1.5% to 11.3% in the sample. An anodic shift in the onset potential can be observed until a nominal nitrogen content of about 10.3%. Beyond this, a further increase in nominal nitrogen content results in a very high overpotential towards ORR, primarily because of the excess amount of bipyridine that is not effectively decomposed during pyrolysis. As evident from Table 1, a huge increase in the mass obtained after pyrolysis can be observed and this reaffirms that the bi-pyridine has not decomposed completely. The high pressure pyrolysis was carried out in a stainless steel bomb and in order to evaluate the leaching effects of iron from the bomb, a sample was synthesized without the presence of any metal and after pyrolysis, this sample was tested. The electrochemical activity of this catalyst is shown in FIG. 4 and as observed there is a 100 mV cathodic shift in the potential when compared with the optimized 10.3% nitrogen content. This reinstates the significance of the metal precursor in the generation of active sites.

Koutecky-Levich analysis for the first order oxygen reduction reaction on the catalysts having a nominal nitrogen content of 10.3% and the chosen potential window for the same was between 0.65V to 0.5V. The kinetic current can be obtained using the following reaction.

$$\frac{1}{i} = \frac{1}{{i}_{k}} + \frac{1}{{i}_{d}} = \frac{1}{{i}_{k}} + \frac{1}{B \cdot {C}_{0} \cdot {ω}^{1 / 2}}$$

Where B is the Levich slope given as

B=0.62nFScD^{2/3}v^{-1/6}

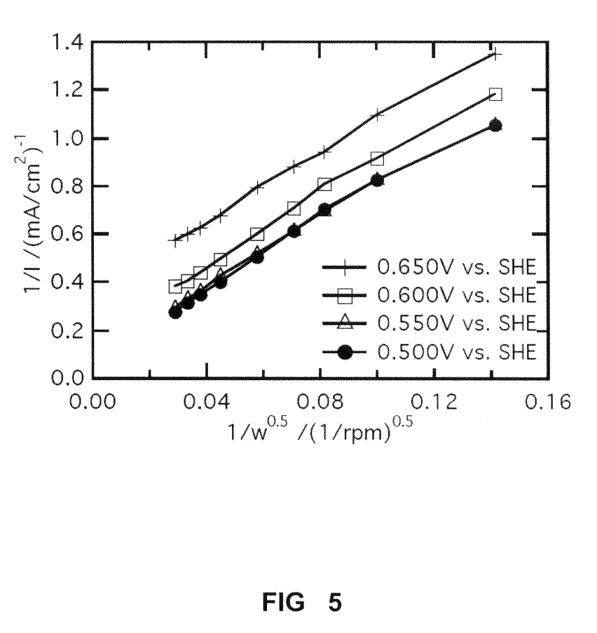

FIG. 5 shows the some typical plots of 1/I versus ω-½ for various potentials in the range of 0.65V to 0.5V vs. SHE. Linearity in the fit can be observed at all potentials with less than 2% error in standard deviation. The near parallelism of the slopes obtained from these plots indicates that there is no change in the reaction mechanism and the number of electrons exchanged does not vary substantially in these potential ranges. The number electron is estimated through this analysis is close be 4.39, and the values of the constants used in the calculations are Dₒ2=2.1*10-5 cm²/s, Cₒ2=1.03*10⁻⁶ mol/cm³, kinematic viscosity v=0.01 cm²/s.

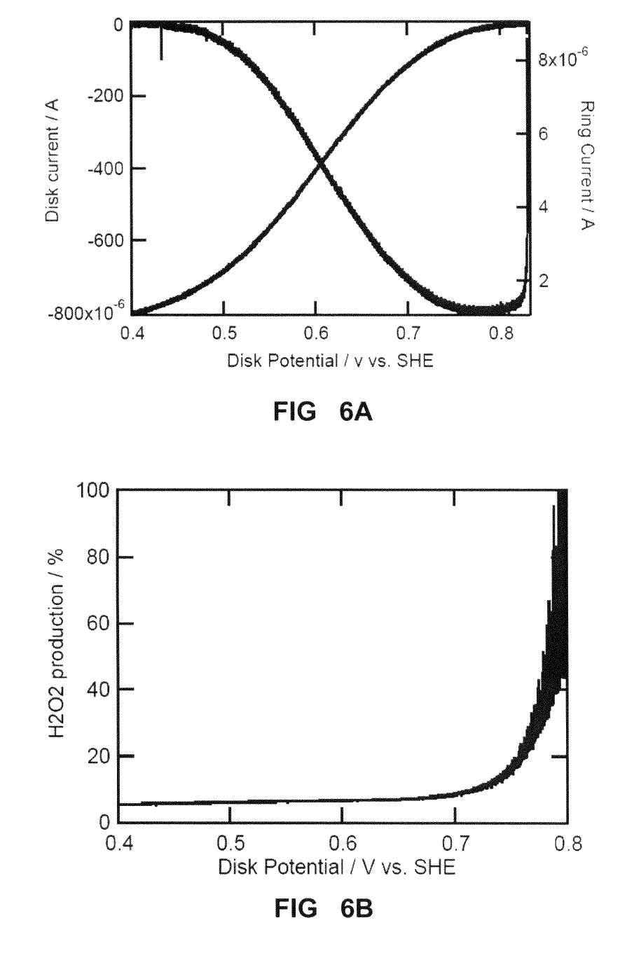

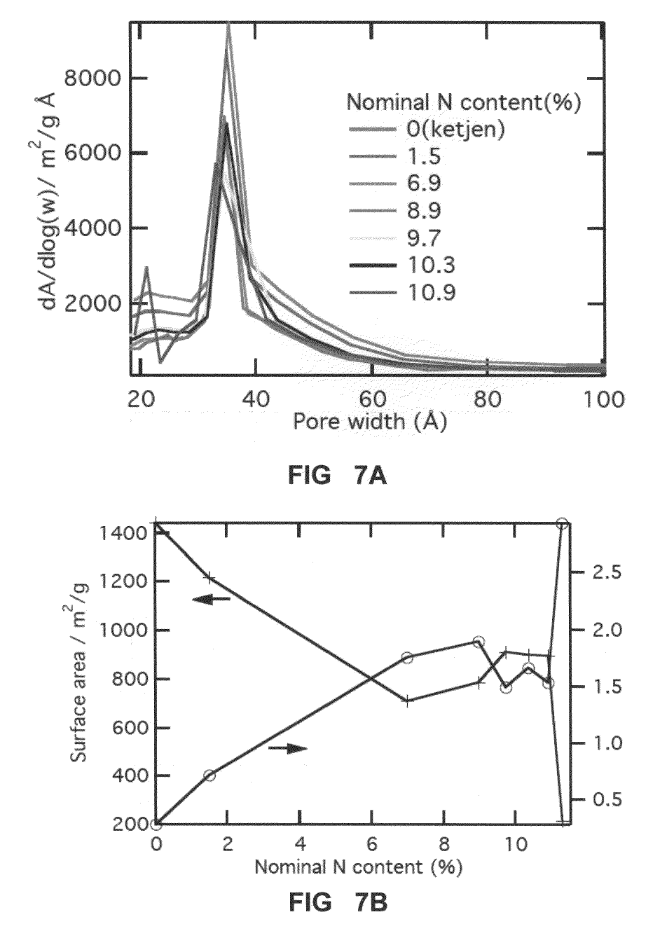

In order to evaluate the amount of hydrogen peroxide produced and hence the selectivity of the reduction of oxygen to water, a rotating ring disc electrode (RRDE) was used instead of an RDE. The disc potential was scanned at a rate of 0.5 mV/s, while the ring electrode was held at 1.2V vs. SHE, a potential sufficiently high to oxidize any peroxide if generated. FIG. 6A shows the disk and ring currents obtained using the optimized catalysts. The polarization curve obtained on ring is similar in shape to disk current, and shows well-defined plateau where disk-current shows plateau. The number of electrons involved in the reaction and the amount of hydrogen peroxide evolved can be obtained employing following equations.

$$n = \frac{4 \cdot {I}_{D}}{{I}_{D} + ( \frac{{I}_{R}}{N} )}$$

$$\% {H}_{2} {O}_{2} = 100 * \frac{( 4 - n )}{2}$$

Where n is the number of electrons transferred and N is the collection efficiency, which is 0.39 for our system. FIG. 6B shows a maximum H₂O₂ generation of about 7% while scanning the disk potential from 0.8-0.4V vs. SHE. In order to correlate the catalytic activity with respect to the surface area of the catalysts, BET surface area measurements on the catalyst surface were performed and area/pore volume distribution extracted from BJH desorption is shown in FIG. 7A. Initially a decrease in BET surface area from 1440 m²/g to 711 m²/g can be observed, which could be due to the reduction in the area of pores less than 4 nm. However, when the N content is increased beyond 6.9%, the surface area begins to raise up to 914 m²/g, which could be due to the formation of new pores of that are greater than 3 nm in size. As shown in FIG. 7B when the nitrogen content is increased beyond 10.9%, there is a sudden decrease in the surface area, which is due to the increased mass of catalyst due to the partial decomposition of bipyridine.

What is claimed is:

1. A method for making an oxygen reducing cathode catalyst, the method comprising:
(a) mixing a carbon source with a transitional metal precursor to form a metal precursor loaded carbon substrate;
(b) adding a nitrogen precursor compound to the metal precursor loaded carbon substrate to form a carbon-metal-nitrogen precursor; and
(c) pyrolyzing the carbon-metal-nitrogen precursor in a closed vessel, thereby forming the oxygen reducing cathode catalyst.

2. The method of claim 1, wherein the carbon source is one or more of Norit® SX Ultra, Ketjenblack®, pyrolyzed perylene tetracarboxylic anhydride (PTCDA), polyacrylonitrile (PAN), Black Pearls®, Printex® XE2, pyrrole black, graphitic powder, acetylene black, Vulcan® XC72, oxidized carbon supports, and metal carbides.

3. The method of claim 2, wherein the carbon source is Ketjenblack®.

4. The method of claim 1, wherein mixing the carbon source with a transitional metal precursor further comprises stirring the carbon source with the transitional metal precursor in a solvent for up to 12 hours.

5. The method of claim 4, wherein the mixing the carbon source with a transitional metal precursor further comprises evaporating the solvent to form the carbon-metal substrate.

6. The method of claim 1, wherein the transitional metal precursor comprises a cation selected from the group consisting of iron, cobalt, nickel, chromium, cerium, zinc, zirconium, molybdenum, manganese, and mixtures thereof.

7. The method of claim 6, wherein the transitional metal precursor comprises an anion selected from the group consisting of acetate, chloride, nitrate, sulfate, and combinations thereof.

8. The method of claim 7, wherein the transition metal precursor is iron (II) acetate.

9. The method of claim 1, wherein the nominal amount of the metal precursor added to the carbon source to form said metal precursor loaded carbon substrate ranges from 1% to about 8% by weight of the substrate.

10. The method of claim 1, wherein the nitrogen precursor is selected from the group consisting of poly(quinoxaline), nitroaniline, 1,10 phenanthroline, pthalocyanine, pyridine, bipyridine, polyaniline, pyrrole, polyvinyl pyridine, 3-nitrophalimide, p-phenylazophenol, 6-quionoline carboxylic acid, 6-nitrobenzimidazole, 5-amino 6-nitro quinoline, 2,3 naphthalocyanine, 4,4′-azoxydibenzoic acid, 2 amino 5-nitro pyrimidine, hematin, 4,4′ azo-bis[cyanovaleric acid], heamotoporpyrindihydrochloride, 4,4′ nitrophenyl azo catechol 4,6 dihydroxy pyrimidine, nitrophenyl, benzylamine, 1,6 phenylendiamine, tetracyanoquinodimethane, propylene di-amine, ethylene di-amine, urea, selenourea, thiourea, dimethylformamide, tetrahydrofuran, ammonia, acetonitrile and polymers, and combinations thereof.

11. The method of claim 10, wherein the bipyridine is 2,2′ bipyridine.

12. The method according to claim 10, wherein the nominal amount of nitrogen in the carbon-metal-nitrogen precursor ranges from about 1.0% to about 15% by weight of the carbon-metal-nitrogen precursor.

13. The method of claim 1, wherein the pyrolyzing step is performed at a temperature of at least 700° C.

14. The method of claim 1, wherein the pyrolyzing step is performed at a temperature of at least 800° C.

15. The method of claim 1, wherein the pyrolyzing step is performed at a temperature of at least 900° C.

16. The method of claim 1, wherein the pyrolyzing step comprises pyrolyzing the carbon-metal-nitrogen precursor in a closed vessel, pressurized up to 100 bar while pyrolyzing.

17. The method of claim 16, wherein the reaction vessel comprises quartz.

18. The method of claim 1, wherein the pyrolyzing step further comprises pyrolyzing the carbon-metal-nitrogen precursor using a spray pyrolysis apparatus.

19. The method according to claim 1, wherein the transitional metal precursor is a transitional metal macrocycle, a transition metal salt, or combination thereof.

20. The method of claim 19, wherein the transitional metal macrocycle comprises cobalt pthalocyanine, iron pthalocyanine, cobalt tetraazannulene, iron tetramethoxy phenyl porpyrin chloride, tetracarboxylic cobalt, iron pthalocyanine, tetramethoxy phenyl porpyrin chloride, cobalt salen-N,N′ bissalicylidine, ethylenediaminocobalt, cobalt-anten-O-amino, ferrocene, benzaldehyde, ethylenediamino cobalt, iron phenanthroline, or combinations thereof.

21. A method for preparing a carbon-metal-nitrogen oxygen reducing cathode catalyst for a fuel cell, the method comprising:
(a) mixing a carbon source with a transitional metal precursor to form a metal precursor loaded carbon substrate;
(b) pyrolyzing the metal precursor loaded carbon substrate in a reducing or neutral environment in a vessel charged at a pressure ranging from about 2 bar to about 100 bar to form a carbon-metal nanostructure; and
(c) contacting the surface of the pyrolized carbon-metal nanostructure with a nitrogen precursor compound to form a carbon-metal-nitrogen cathode catalyst.

22. The method of claim 21, wherein the carbon source is one or more of Norit SX Ultra®, Ketjenblack®, pyrolyzed perylene tetracarboxylic anhydride (PTCDA), polyacrylonitrile (PAN), Black Pearls®, Printex® XE2, pyrrole black, graphitic powder, acetylene black, Vulcan® XC72, oxidized carbon support, and metal carbides.

23. The method of claim 22, wherein the carbon source is Ketjenblack®.

24. The method of claim 21, wherein mixing the carbon source with a transitional metal precursor further comprises stirring the carbon source with the transitional metal precursor in a solvent for up to 12 hours.

25. The method according to claim 21, wherein the transitional metal precursor is a transitional metal macrocycle, a transition metal salt, or combination thereof.

26. The method of claim 25, wherein the transitional metal macrocycle comprises cobalt pthalocyanine, iron pthalocyanine, cobalt tetraazannulene, iron tetramethoxy phenyl porphyrin chloride, tetracarboxylic cobalt, iron pthalocyanine, tetramethoxy phenyl porphyrin chloride, cobalt salen-N,N′bis-salicylidine, ethylenediaminocobalt, cobalt-anten-O-amino, ferrocene, benzaldehyde, ethylenediamino cobalt, iron phenanthroline, or combinations thereof.

27. The method of claim 25, wherein the transitional metal salt comprises at least one cation selected from the group consisting of iron, cobalt, nickel, chromium, cerium, zinc, zirconium, molybdenum, manganese, and mixtures thereof.

28. The method of claim 28, wherein the transitional metal salt comprises at least one anion selected from the group consisting of acetate, chloride, nitrate, sulfate, and mixtures thereof.

29. The method of claim 26, wherein the transition metal salt is iron acetate.

30. The method of claim 21, wherein the nominal amount of the transitional metal precursor added to the carbon source to form the metal precursor loaded carbon substrate ranges from 1% to about 8% by weight of the substrate.

31. The method of claim 21, wherein the pyrolyzing step is performed at a temperature ranging between 600° C. and 900° C.

32. The method of claim 21, wherein the reaction vessel comprises quartz.

33. The method of claim 21, wherein the pyrolyzing step further comprises pyrolyzing the metal precursor loaded carbon substrate using a spray pyrolysis apparatus.

34. The method of claim 21, wherein the nitrogen precursor is selected from the group consisting of poly(quinoxaline), nitroaniline, 1,10 phenanthroline, pthalocyanine, pyridine, bipyridine, polyaniline, polyvinyl pyridine, 3-nitrophalimide, p-phenylazophenol, 6-quionoline carboxylic acid, 6-nitrobenzimidazole, 5-amino 6-nitro quinoline, 2,3 naphthalocyanine, 4,4′-azoxydibenzoic acid, 2 amino 5-nitro pyrimidine, hematin, 4,4′ azo-bis[cyanovaleric acid], heamotoporpyrindihydrochloride, 4,4′ nitrophenyl azo catechol 4,6 dihydroxy pyrimidine, benzoic acid, nitrophenyl, benzylamine, 1,6 phenylendiamine, xylene, tetracyanoquinodimethane, propylene di-amine, ethylene di-amine, urea, selenourea, thiourea, dimethylformamide, tetrahydrofuran, ammonia, acetonitrile, and combinations thereof.

35. The method of claim 34, wherein the bipyridine is 2,2′ bipyridine.

36. The method according to claim 21, wherein the nominal amount of nitrogen in the carbon-metal-nitrogen precursor ranges from about 1.5% to about 15% by weight of the carbon-metal-nitrogen precursor.

37. The method according to claim 21, further comprising thermal treating the nitrogen precursor contacted surface using one of high temperature arc discharge and laser ablation.

38. A low temperature fuel cell comprising the oxygen reducing cathode catalyst of claim 1.

39. A method for making a membrane electrode assembly for a fuel cell, the membrane electrode assembly comprising:
(a) providing an ionomeric membrane, the membrane having a first side and a second side;
(b) applying an anode catalyst on at least a portion of the first side of the ionomeric membrane; and
(c) applying an cathode catalyst on at least a portion of the second side of the ionomeric membrane, wherein the cathode catalyst is synthesized by:
(i) mixing a carbon source with a transitional metal precursor to form a metal precursor loaded carbon substrate;
(ii) adding a nitrogen precursor compound to the metal precursor loaded carbon substrate to form a carbon-metal-nitrogen precursor; and
(iii) pyrolyzing the carbon-metal-nitrogen precursor in a closed vessel, thereby forming an oxygen reducing cathode catalyst, and
(iv) mixing the oxygen reducing cathode catalyst with a recast ionomer.

40. The method according to claim 39, wherein the anode catalyst comprises a catalyst ink having at least one transition metal selected from the group consisting of platinum, ruthenium, palladium, and combinations thereof.

41. The method according to claim 39, wherein the recast ionomer is poly(perfluorosulphonic acid).
